(19) United States
(12) Patent Application Publication
(10) Pub. No.: US 2025/0258020 A1
(43) Pub. Date: Aug. 14, 2025

(54) INDUCTIVE SENSOR DEVICE

(71) Applicant: Carl Mahr Holding GmbH, Goettingen (DE)

(72) Inventor: Jonas KALTENHÄUSER, Goettingen (DE)

(21) Appl. No.: 19/050,389

(22) Filed: Feb. 11, 2025

(30) Foreign Application Priority Data
Feb. 13, 2024 (DE) 10 2024 103 963.9

(51) Int. Cl. G01D 5/20; G01B 7/02

(52) U.S. Cl. CPC G01D 5/2093; G01B 7/02

(57) ABSTRACT

An inductive sensor device has a scale body having a multiplicity of conductor strip loops arranged in a measurement direction in at least one scale line. A sensor unit is moveable along the scale body and has one coil group for each scale line, the coil group comprising a transmitter coil for producing a transmitter signal and at least one receiver coil. Each coil group provides at least one receiver signal for an evaluation unit for determination of an absolute relative position of the sensor unit relative to the scale body. At least one of the scale lines has at least one modulating section, within which the impedances and/or the apparent resistances of conductor strip loops change from one end of the modulating section to the other, whereby the at least one receiver signal is modulated with regard to its phase position relative to the transmitter signal.

### CROSS REFERENCE TO RELATED APPLICATION

This application claims the benefit of German Patent Application No. 10 2024 103 963.9, filed Feb. 13, 2024, which is incorporated herein by reference in its entirety.

### TECHNICAL FIELD

The invention refers to an inductive sensor device comprising a sensor unit that can be moved along a scale body in order to determine the position between the sensor unit and the scale body. Thereby particularly the absolute position between the sensor unit and the scale body is determined.

### BACKGROUND

Such inductive sensor devices are, for example used for measurement devices, such as calipers.

For example, DE 10 2004 026 311 A1 describes an inductive sensor device. Two transmitter coils are provided in a sensor unit that can be moved along a scale body, wherein the transmitter coils are enclosed by a receiver coil. The scale body comprises scale elements that can effect a magnetic coupling with the transmitter coils and the receiver coil so that a movement of the sensor unit along the scale body can be detected.

Another inductive sensor device is known from DE 102 02 275 B4. The scale elements for inductive coupling with the sensor unit comprise two loops connected with one another via connection lines. For forming a vernier the loops are arranged in two lines with different divisions (distances). In doing so, the length of the connection lines between two loops of a common scale element changes. In order to compensate a longer length of the connection lines, the width of the conductors of the loops and the connection lines can be modified so that the signal strength (amplitude) is not degraded.

In addition, an inductive sensor device is known from EP 3 594 629 A1. The scale body comprises two lines of scale elements, wherein the scale elements of one line have first distance between adjacent scale elements and the scale elements of the other line have a second distance between adjacent scale elements in order to form a vernier. Thereby the measurement range for the absolute position measurement between the sensor unit and the scale body can be extended. In addition, the scale elements of one line are varied in their height, whereby an amplitude-modulated signal is produced in the sensor unit during inductive coupling with the scale elements. This shall allow an additional extension of the absolute measurement range.

An inductive sensor device according to the vernier principle (nonius) is also described in U.S. Pat. No. 6,335,618 B1.

In these methods using the amplitude modulation of the signals in the sensor unit is disadvantageous. The amplitude of the signals generated in the sensor unit for position determination highly depends on the relative orientation of the sensor unit relative to the scale body. Varying distances and inclinations or tilts result in changes of the amplitude, which impedes the determination of the position and increases the measurement uncertainty. In addition, the amplitude also remarkably depends on the excitation field of a transmitter coil of the sensor unit and thus from the excitation current through the transmitter coil. Fluctuations in the excitation current thus affect the position determination based on an amplitude modulation in a negative manner as well. Also temperature deviations influence the amplitude, because the resistance in the conductors varies depending on the temperature.

The amplitude modulation is disadvantageous also because the modulation depth or the modulation range is limited. This is because a sufficient signal to noise ratio has to always be guaranteed.

Additional inductive sensor devices are described in EP 0 743 508 A2, EP 3 299 770 A1 and US 2016/0146636 A1, for example.

### SUMMARY

Starting from the prior art it can be considered as one object of the present invention to provide an inductive sensor device that can be realized economically that comprises a sufficiently large measurement range for the absolute position determination and that allows high tolerances for assembly.

This object is solved by means of an inductive sensor device as described herein.

The inductive sensor device comprises a scale body, a sensor unit and an evaluation unit. The evaluation unit can be part of the sensor unit. The sensor unit is movably supported on the scale body in a measurement direction. The scale body can in one embodiment extend along a straight line in measurement direction. Depending on the application (e.g. depending on the configuration of a measurement device, in which the inductive sensor device is used), the measurement direction can also have a curved extension, particularly along a circular arc.

The scale body has a multiplicity of electrically conductive conductor strip loops. The conductor strip loops are arranged in at least one scale line, preferably in multiple and particularly in exactly two scale lines. The at least one scale line extends in measurement direction. If multiple scale lines are present, they are arranged offset in a transverse direction relative to one another. The transverse direction is orientated orthogonal to the measurement direction. It is advantageous, if the conductor strip loops are arranged in a common plane, wherein this plane is orientated parallel to the measurement direction and parallel to the transverse direction.

If multiple scale lines are present, the conductor strip loops in the scale lines are arranged with at least two different divisions, particularly with a first division in a first scale line and with a second division in a second scale line. The first division and the second division distinguish from each other and preferably form a vernier. The division in each scale line is preferably constant.

The division is defined by the distance of two reference points in measurement direction between directly adjacent conductor strip loops in the respective individual scale line. For example, the reference points can be located on a center line of the conductor strip loops respectively, wherein the center line extends in the center between the outer edges of each conductor strip of a conductor strip loop.

If more than two scale lines are present in an embodiment, these additional scale lines can comprise a division that distinguishes from the first division and the second division, wherein particularly each present scale line comprises a different division.

The sensor unit has a coil group for each provided scale line, wherein the coil group comprises at least one and preferably exactly one transmitter coil and at least one and preferably two and particularly exactly two receiver coils. A transmitter signal can be provided to the transmitter coil, e.g. by means of a transmitter unit of the inductive sensor device. Each receiver coil provides a receiver signal for the evaluation unit respectively. The transmitter unit and the evaluation unit can be realized as separate component groups or in a common control. The transmitter unit can be part of the sensor unit analog to the evaluation unit.

The evaluation unit is configured to evaluate the receiver signals and to determine therefrom an absolute relative position between the sensor unit and the scale body. Based on this absolute relative position, a measurement value can be determined and output, for example, if the inductive sensor device is part of a measurement device.

With view in measurement direction the scale line or at least one of the scale lines and preferably each scale line has a modulation section. The modulation section is preferably shorter in measurement direction than the total length of the scale line. Alternatively in an embodiment one single modulation section can extend along the entire scale line in measurement direction. In each modulation section the conductor strip loops, which are provided there, have impedances and/or apparent resistances, which distinguish from one another. Within the modulation section the impedances and/or apparent resistances either increase or decrease from one end of the modulation section to the opposite end of the modulation section with view in measurement direction. Preferably the impedance and/or the apparent resistance changes within the modulation section from each conductor strip loop to the next conductor strip loop. The conductor strip loop arranged at the one end of the modulation section has the lowest impedance and/or the lowest apparent resistance within the modulation section, whereas the conductor strip loop arranged at the opposite end of the modulation section comprises the largest impedance and/or the largest apparent resistance in the modulation section.

Here, the apparent resistance is the magnitude of the impedance. The impedance has a reactance (e.g. an inductive reactance) and an ohmic resistance.

In the at least one modulation section the impedance and/or the apparent resistance is preferably varied so that the ratio of the reactance to the ohmic resistance changes.

Due to the impedances and/or apparent resistances changing in the modulation section, the receiver signal respectively provided by the at least one assigned receiver coil is influenced and so-to-speak modulated. In doing so, an additional parameter is provided that is considered during determination of the absolute relative position.

Due to the modulation of the receiver signal based on the changing impedances and/or apparent resistances, a robust determination of the absolute relative position can be carried out that is particularly insensitive for deviations in the relative orientation of the components of the sensor device, particularly the relative orientation between the sensor unit and the scale body. This allows larger assembly and installation tolerances and thus an economic assembly. In addition, the inductive sensor device is insensitive with regard to environmental influences, such as changing environment humidity. The environment temperature can particularly influence the ohmic resistance of the conductor strip loops and/or effect a phase drift of the transmitter signal, if the transmitter signal is not an impressed transmitter current, but an impressed transmitter voltage. However, the design can be made insensitive to temperature influences as will be apparent from the detailed description below.

These advantages result particularly from that the impedances and/or apparent resistances changing within the modulation section allow a modulation along the at least one scale line with regard to the phase position of the receiver signals relative to the transmitter signal. As phase position here the phase difference between the phase of at least one receiver signal relative to the phase of the transmitter signal is meant. The evaluation of the phase position is much more robust against deviations in the relative orientation between sensor unit and scale body and remarkably less sensitive against temperature changes or other environmental influences different to the evaluation of an amplitude in the context of an amplitude modulation.

In addition, the modulation of the receiver signals according to the invention can be realized with standard components. Particularly no application-specific integrated circuit (ASIC) is required in the evaluation unit, but the evaluation unit can be realized by means microcontrollers available on the market.

All in all, an economic sensor device can be provided that is robust against assembly errors or assembly deviations (large tolerance range) that is robust against environmental influences and yet allows a long measurement range in measurement direction for determination of the absolute relative position.

It is advantageous, if all of the conductor strip loops have impedances and/or apparent resistances that are different from one another within the at least one modulation section. The impedance and/or apparent resistance therefore increases or decreases from each conductor strip loop to the directly adjacent conductor strip loop. Basically, it would also be possible to form multiple groups of conductor strip loops within the modulation section, wherein the conductor strip loops of a common group comprise equal impedances and/or apparent resistances.

The impedance and/or apparent resistance can change in measurement direction within the at least one modulation section in a non-linear manner. This means a change within the modulation section in which the individual impedances and/or apparent resistances of the conductor strip loops in a diagram, depending on a linearly indicated measurement direction, are not points on a common straight line, but are, for example, points on a curve (non-linear function).

The impedance and/or the apparent resistance can be predefined in measurement direction in the at least one modulation section, so that in a desired operating point the magnitude of the reactance is equal to the magnitude of the ohmic resistance. When the magnitudes of the reactance and ohmic resistance are equal, a fractional change in impedance gives the biggest change in the phase of the receiver signals. Preferably this operating point is at least substantially an average value of the varying impedance and/or apparent resistance around which the impedance and/or apparent resistance changes approximately by equal amount upward and downward.

It is preferred, if the impedance and/or apparent resistance is changed within the at least one modulation section between conductor strip loops by means of a change of the ratio between the reactance and the ohmic resistance. Preferably this change of the impedance and/or apparent resistance is exclusively realized by a change of the ohmic resistance, whereas the reactance of the conductor strip loops is substantially constant.

In a preferred embodiment the change of the impedance and/or apparent resistance between the conductor strip loops within the at least one modulation section can be realized by conductor strip cross-sections, particularly conductor strip widths, which are different from one another. Thereby the conductor strip width of the conductor strip loops increases or decreases from one end of the modulation section to the opposite end of the modulation section. The conductor strip width is measured orthogonal to its extension direction and particularly orthogonal to the outer edges of the conductor strip. The change of the conductor strip width for the conductor strip loops within the modulation section can be realized in a very simple manner.

The change of the conductor strip width from one conductor strip loop to another conductor strip loop within the modulation section is carried out preferably originating from the conductor strip center in a uniform manner outward and inward. Originating from a center line of the conductor strip, the width therefore increases uniformly on both sides. The larger the conductor strip width, the longer the outer circumference of the conductor strip loop and the shorter the inner circumference of the conductor strip loop. Thereby the division remains constant.

In a preferred embodiment the conductor strip loop with larger conductor strip width has a higher loop height in transverse direction and/or a larger loop width in measurement direction.

For changing the impedance and/or apparent resistance between the conductor strip loops within the at least one modulation section, additionally or alternatively to the change of the conductor strip width or the conductor strip cross-section one parameter or multiple of the following parameters can be changed in arbitrary combination: conductor strip thickness, cross-section shape of the conductor strip, material of the conductor strip. All changes can be provided on the conductor strip as a whole or only locally at least at one location of the conductor strip.

The shape of the conductor strip loops can vary. Each conductor strip loop can have at least one straight line conductor strip section and/or at least one curved conductor strip section. It is preferred, if each conductor strip loop comprises two transverse legs extending in a straight line in transverse direction. The two transverse legs are connected with one another by means of two longitudinal legs arranged with distance opposite one another in transverse direction. The longitudinal legs can be straight or curved and can extend parallel or inclined relative to the measurement direction. Particularly the transverse legs and the longitudinal legs have equal widths and define the conductor strip width of the conductor strip loop.

It is preferred, if the conductor strip width within the conductor strip loop does not vary, but is constant on the contrary.

It is advantageous, if all of the conductor strip loops comprise the same conductor strip thickness. The conductor strip thickness is measured orthogonal to the measurement direction and orthogonal to the transverse direction. If the conductor strip thickness of all of the conductor strip loops is equal—apart from manufacturing tolerances—it contributes to easy and economic manufacturing of the conductor strip loops on the scale body.

It is advantageous, if at least one of the provided scale lines comprises a non-modulating section or area extending in measurement direction. Inside this non-modulating section all of the conductor strip loops have substantially equal impedance and/or apparent resistance. For example, a non-modulating section can be arranged between two modulation sections of a scale line. If one of the scale lines comprises a non-modulating section, the at least one other scale line has a modulation section in this area. If multiple modulation sections are present, they can have equal or different lengths in measurement direction.

In a non-modulating section of a scale line all of the conductor strip loops preferably have equal conductor strip width and preferably equal loop height and/or equal loop width.

It is preferred, if the first scale line and the second scale line have at least one non-modulating section in each case. The non-modulating sections of the first scale line and the second scale line are arranged offset in a non-overlapping manner in measurement direction.

Due to the at least one non-modulating section in one or multiple scale lines, the measurement range for determination of the absolute relative position can be extended.

The evaluation unit is preferably configured to determine a phase signal from at least one of the receiver signals, wherein the phase signal is an electrical signal, for example. The phase signal describes particularly the phase shift between the transmitter signal, e.g. an excitation or transmitter coil current through the at least one transmitter coil, and a conductor strip loop current. The conductor strip loop current is induced in one and particularly multiple conductor strip loops arranged adjacent in measurement direction, due to the transmitter signal applied to the transmitter coil.

In a preferred embodiment the evaluation unit is configured to sample at least one of the receiver signals, multiple receiver signals or all of the receiver signals one time or multiple times in order to determine the phase of the respective receiver signal. Multiple sampling can be carried out in one single period and/or over multiple periods for determining a respective sample value for the assigned receiver signal respectively. The sampling points in time are offset in phase relative to the periodic receiver signal, e.g. by 90°. It is particularly advantageous, if sampling is carried out in four sampling points in time of the respective receiver signal, which are offset in phase relative to one another, so that four sampling values are provided. Preferably, the sampling is carried out in regular phase or time intervals. If for example the first sampling point in time t1 is offset from a zero crossing of the periodic receiver signal by a phase difference q, the additional sampling points in time t(1+i) with i=1, 2, 3, 4, . . . , iₘₐₓ can be offset relative to this zero crossing by q+i*d+n*360° with n=0, 1, 2, 3, . . . and wherein d is a defined phase offset, e.g. 90°, whereby it particularly applies:

$$d = 360 ° / ( 1 + {i}_{max} ) .$$

In an embodiment the sampling can be based on the IQ-method.

From the sampling values of a receiver signal respectively one phase value can be determined by means of the evaluation unit, wherein the phase value characterizes the phase of the receiver signal. From these phase values in turn the phase signal can be formed that is considered when determining the absolute relative position.

If four sampling values E₁, E₂, E₃ and E₄ are determined for one assigned receiver signal, the phase value y for the phase signal can be determined as follows:

$${E}_{13} = {E}_{1} - {E}_{3} \qquad ( 1 )$$

$${E}_{24} = {E}_{2} - {E}_{4} \qquad ( 2 )$$

$$φ = arc tan 2 ( {E}_{13} , {E}_{24} ) \qquad ( 3 )$$

### BRIEF DESCRIPTION OF THE DRAWINGS

Advantageous embodiments of the invention are derived from the dependent claims, the description and the drawing. In the following preferred embodiments of the invention are explained in detail based on the attached drawing. The drawing shows:

FIG. 1 a schematic basic illustration of an exemplary measurement device that is equipped with a sensor device according to the present invention,

FIG. 2 a basic circuit diagram of an embodiment of a sensor device,

FIGS. 3 and 4 exemplary time-dependent progresses of a transmitter signal, a conductor strip loop current induced due to the transmitter signal in a conductor strip loop of the sensor device and a receiver signal in each case,

FIG. 5 an exemplary schematic illustration of scale elements in two scale lines having respectively two modulation sections,

FIG. 6 exemplary basic illustration of phase signals over the entire absolute measurement range, as determined in an evaluation unit of the sensor device for determination of the absolute relative position,

FIG. 7 a basic illustration of a phase difference of phase signals,

FIG. 8 a basic illustration of conductor strip loops of the sensor device in a modulation section,

FIG. 9 a basic illustration of a measurement coil for determination of a phase of a transmitter signal,

FIG. 10 a basic illustration of the arrangement of components of an evaluation unit on a circuit board of the sensor device, and

FIG. 11 an exemplary phase trajectory showing the correlation of two phase signals from one another.

### DETAILED DESCRIPTION

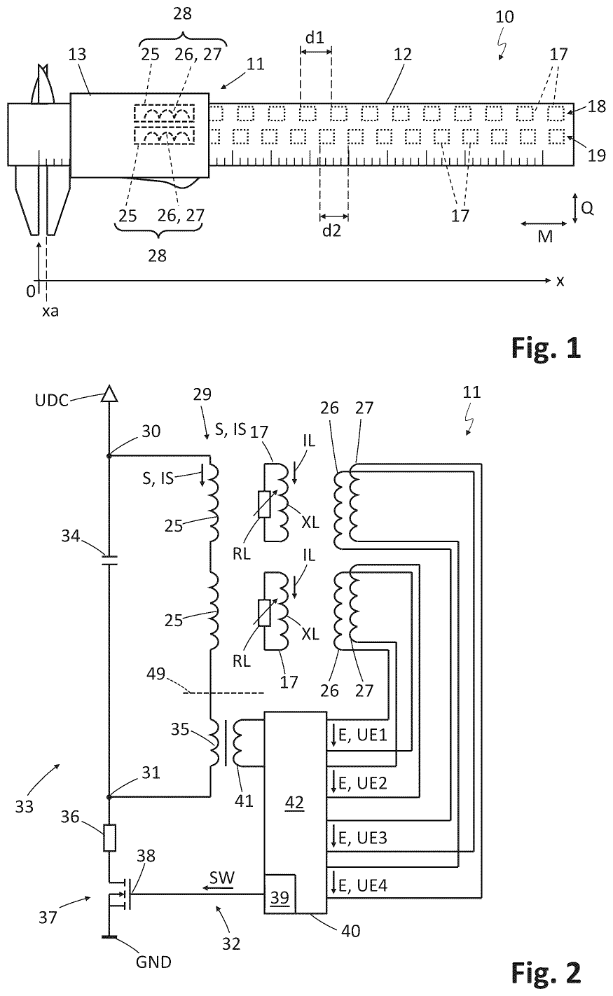

FIG. 1 shows an exemplary embodiment of a measurement device or measurement instrument 10 in form a caliper. The measurement instrument 10 is configured as digital measurement instrument. In the embodiment the measurement instrument 10 is configured to measure a distance or a length measurement value. For this measurement the measurement instrument 10 comprises an inductive sensor device 11 according to the present invention.

The inductive sensor device 11 comprises a scale body 12 extending in a measurement direction M and a sensor unit 13 that is movably supported in measurement direction M on the scale body 12. In the embodiment of measurement instrument 10 in form of a caliper the measurement direction M is a linear direction. In other measurement instruments or applications the measurement direction M of the inductive sensor device 11 could also extend in a curved manner, e.g. along a circular arc. The function principle of the inductive sensor device 11 according to the invention is also applicable in devices (e.g. measurement instruments) in which the measurement direction M does not extend in straight direction.

The scale body 12 comprises a multiplicity of scale elements that are configured as conductor strip loops 17. The conductor strip loops 17 are arranged in multiple lines according to the example, in the present case in a first scale line 18 and a second scale line 19. Alternatively to this, also one single scale line or more than two scale lines could be present. The scale lines 18, 19 extend parallel to one another in measurement direction M. In a transverse direction Q that is orientated orthogonal to the measurement direction M, first scale line 18 and second scale line 19 are offset to each other and particularly arranged with distance to one another.

The conductor strip loops 17 are arranged in the first scale line 18 with a first division d1. The conductor strip loops 17 are arranged in the second scale line 19 with a second division d2. The division d1 and the division d2 have different magnitudes. They form a vernier.

The conductor strip loops 17 consist of electrically conductive material, e.g. copper, or contain at least electrically conductive material. The individual conductor strip loops 17 are electrically insulated from each other. The conductor strip loops 17 are configured in a ring-shaped closed manner, so that a conductor strip loop current IL can flow along a conductor strip loop 17 (see for example FIG. 2). The conductor strip loop current IL can be induced in the inductive sensor device 11 by means of temporally or spatially changing magnet field in one or multiple conductor strip loops 17.

In the embodiment all of the conductor strip loops 17 are arranged in a common plane, which extends parallel to the measurement direction M and parallel to the transverse direction Q. The contour of the conductor strip loops 17 can be selected differently. In the embodiment illustrated here each conductor strip loop 17 is formed by one conductor strip that has two straight transverse legs 20 arranged with distance to one another in measurement direction M and extending in transverse direction Q (FIGS. 1, 5 and 8). The two transverse legs 20 are connected to form a closed ring by means of two longitudinal legs 21 of the conductor strip loops 17. The two longitudinal legs 21 are arranged with distance to one another in transverse direction Q. In the embodiment the longitudinal legs 21 are straight and extend in measurement direction M. In modification to this the longitudinal legs 21 could also have a curved extension and could be semi-circular-shaped, for example.

The shape of the conductor strip loops 17 is particularly apparent from FIG. 8. There it is also apparent that each conductor strip loop 17 comprises a center line C that extends in the center along the conductor strip of each conductor strip loop. The sections of the center line C extending along the transverse legs 20 serve as reference for definition of the first division d1 and the second division d2, as illustrated in FIG. 8.

The sensor unit 13 of the inductive sensor device 11 comprises one transmitter coil 25 and at least one receiver coil, e.g. a first receiver coil 26 as well as a second receiver coil 27 for each present scale line respectively, thus, according to the example, for the first scale line 18 and the second scale line 19 in each case. The first receiver coil 26 and the second receiver coil 27 assigned to a common scale line 18 or 19 are offset relative to each other in measurement direction M. For example, the receiver coils 26, 27 can be realized by loops. The coil loop can be formed by means of two conductor strip portions extending in a sinusoidal-shaped manner, which are offset by half of the wavelength of the division d1, d2 of the respective scale line 18 or 19 relative to one another. Due to the offset of the first receiver coil 26 relative to the second receiver coil 27, the receiver signals thereof are out of phase to one another, for example by 90°.

The transmitter coil 25 can surround the two receiver coils 26, 27 that are assigned to the same scale line 18 or 19 and can preferably at least approximately form an envelope around the receiver coils 26, 27. The transmitter coil 25 is particularly formed by one single transmitter coil loop or by multiple transmitter coil loops that are arranged aligned in measurement direction M and in transverse direction Q.

Accordingly, exactly one transmitter coil 25, exactly one first receiver coil 26 and exactly one second receiver coil 27 form one common coil group 28 respectively (FIG. 1). Additional transmitter and receiver coils are not necessary. In the embodiment exactly one coil group 28 of the sensor unit 13 is assigned to each scale line 18, 19. The coil groups 28 are highly simplified schematically illustrated in FIG. 1.

FIG. 2 shows an electrical circuit diagram of an embodiment of the inductive sensor device 11. The transmitter coils 25 are connected in series to one another in a circuit branch 29. The circuit branch 29 connects a first node 30 with a second node 31. The circuit branch 29 is a two-terminal network according to the example. It can consist exclusively of a series connection of components.

By means of a transmitter circuit 32 a transmitter signal S can be provided for the transmitter coils 25. Alternatively to the embodiment according to FIG. 2, it is possible to provide one individual transmitter circuit for each transmitter coil. In the embodiment the transmitter signal S is a transmitter coil current IS. The transmitter coil current IS has a temporally non-constant progress and can be a rectangular wave signal, a triangular signal, a sawtooth signal, a sinusoidal signal or another temporally varying signal, for example. The transmitter circuit 32 comprises a parallel oscillating circuit 33. An oscillating circuit capacitance 34 and an oscillating circuit inductance 35 are part of the parallel oscillating circuit 33. The oscillating circuit capacitance 34 is arranged between the first node 30 and the second node 31. The oscillating circuit inductance 35 is connected in series to the transmitter coils in the circuit branch 29. In the embodiment the oscillating circuit inductance 35 connects the series connection of the transmitter coils 25 with the second node 31. By means of the oscillating circuit inductance 35 and the oscillating circuit capacitance 34, a suitable resonant frequency of the parallel oscillating circuit 33 can be set.

The oscillating circuit capacitance 34 can be realized by one or more capacitors, e.g. multiple capacitors connected in parallel. The oscillating circuit inductance 35 can be realized by one or more coils or windings.

The first node 30 is connected to a supply direct voltage UDC. The supply direct voltage UDC can be provided by means of a battery in a mobile measuring instrument 10, as for example illustrated in FIG. 1. The second node 31 is connected to a ground potential GND via a series resistance 36 and a controlled switch 37. The controlled switch 37 has a control input 38. By means of a respective switch signal SW at the control input 38 the controlled switch 37 can be switched between a conducting condition and a blocking condition. In the conducting condition an electrical connection between the second node 31 and ground potential GND is established, whereas this electrical connection is interrupted in the blocking condition of the controlled switch 37. Particularly the controlled switch 37 can be a semi-conductor switch, e.g. a bipolar transistor or a field effect transistor. The base or gate of the respective transistor is the control input 38 in this case.

A transmitter control unit 39, which can be part of a control device 40, serves for control of the controlled switch 37. The switching of controlled switch 37 is carried out by means of a clocked switch signal SW according to the example, having a clock frequency corresponding approximately to the resonant frequency of the parallel oscillating circuit 33. If the controlled switch 37 is inductive, the oscillating circuit capacitance 34 is loaded, if the controlled switch 37 is blocked, the oscillating circuit capacitance 34 discharges via circuit branch 29 and thus the transmitter coils 25. Thereby the transmitter signal S or the transmitter coil current IS is created, which flows through the transmitter coils 25.

Because of the series connection in the circuit branch 29, the transmitter coil current IS also flows through the oscillating circuit inductance 35. A measurement coil 41 is inductively or in the type of a transformer coupled with this oscillating circuit inductance 35. By means of the measurement coil 41, a measurement signal can be produced, the phase of which corresponds to the phase of the transmitter coil current IS. The measurement coil 41 is electrically connected with an evaluation unit 42 that can be part of the control device 40. The measurement coil 41 provides the measurement signal to the evaluation unit 42. Therefore, the phase of the transmitter coil current IS is known in the evaluation unit 42. In fact, the phase of the transmitter coil current IS results in the ideal case also from the control of the controlled switch 37 and the dimensioning of the parallel oscillating circuit 33. However, in practice deviations can occur resulting from component tolerances and/or temperature changes and/or other external influences. By means of the optionally present measurement coil 41 and determination of the phase of the transmitter coil current IS is guaranteed independent from such influences.

The receiver coils 26, 27 are connected to the evaluation unit 42 of the sensor device 11 and provide the receiver signal E produced by each receiver coil 26, 27 to the evaluation unit. In the embodiment each receiver coil 26, 27 provides a receiver coil voltage UE as receiver signal E to the evaluation unit 42. Because according to the example, two coil groups 28 with respectively one first receiver coil 26 and one second receiver coil 27 are present, four receiver coil voltages UE are provided to the evaluation unit 42, namely a first receiver coil voltage UE1, a second receiver coil voltage UE2, a third receiver coil voltage UE3 as well as a fourth receiver coil voltage UE4.

In the embodiment the control device 40 is a customary microcontroller. Application-specific components are not necessary for realizing the sensor device 11. Alternatively to the embodiment the evaluation unit 42 and the transmitter control unit 39 could also be realized as separate components or component units.

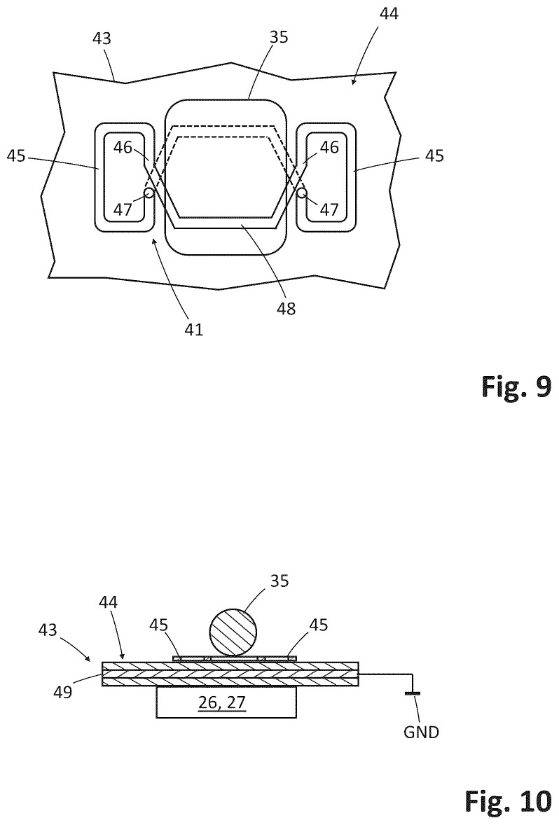

The transmitter circuit 32, the receiver coils 26, 27 and the control device 40 can be arranged on a common carrier of sensor unit 13, e.g. a circuit board 43 (FIGS. 9 and 10). The circuit board 43 is preferably a multi-layer circuit board. On a top side 44 of the circuit board 43 the oscillating circuit inductance 35 can be arranged, for example. The measurement coil 41 can be realized by conductor strips that form one measurement loop 45 respectively on opposite sides of the oscillating circuit inductance 35 on the top side 44. The measurement loops 45 are not entirely closed in a ring-shaped manner, but comprise one first end point 46 and one second end point 47 respectively that are not directly electrically connected with one another, but only via the respective other measurement loop. The first end points 46 and the second end points 47 of the measurement loops 45 are electrically connected with each other respectively. In top view the conductors connecting the measurement loops 45 cross each other two times without being electrically connected at the crossing points (e.g. conductors extend in different layers of the circuit board 43). The two measurement loops 45 thus have the shape of an “8” with a central loop 48 arranged therebetween. TAt the central loop 48 one of the measurement loops 45 is connected to the evaluation unit 42.

The ratio of the total area enclosed by the two measuring loops 45 is relative to the area enclosed by the central loop 48 is a defined parameter. In particular, the ratio can be equal to 1 or can be greater than 1 (i.e. the total area enclosed by both measurement loops 45 exceeds the area enclosed by central loop 48). For example, the ratio can be weighted based on the influence of the oscillating circuit inductance 35 on the far field where the inductance with its ferrite amplifies the far field in the center loop 48. This leads to a higher magnetic flux density compared to that within at least one of the measuring loops 45. Due to defining this ratio as described above, a voltage induced by the magnetic field of the oscillating circuit inductance 35 is amplified and voltage induced by the far field is weakened or ideally extinguished. Due to this configuration of the measurement coil 41, it is avoided that electromagnetic far fields affect the measurement. Please note that FIG. 9 is not drawn to scale but represents the loops 45, 48 only schematically.

In the circuit diagram according to FIG. 2, it is apparent that a shielding 49 can be present between the oscillating circuit inductance 35 and the transmitter coils 25. This shielding 49 serves particularly to protect the oscillating circuit inductance 35 and the measurement coil 41 from electromagnetic influences of the transmitter coils 25, the receiver coils 26, 27 or the conductor strip loops 17 in order to guarantee a precise determination of the phase of the transmitter coil current IS. For example, shielding 49 can be formed by an electrically conductive layer within the circuit board 43 that is electrically connected with ground potential GND (FIG. 10). The receiver coils 26, 27 and as an option, additional components of the circuit can be arranged on the respective opposite side of the shielding 49 (e.g. in a layer of the circuit board), as schematically illustrated in FIG. 10.

Based on the circuit diagram in FIG. 2, it is also apparent that each conductor strip loop 17 can be illustrated as closed current circuit in which an inductive reactance XL and an ohmic resistance RL of the conductor strip loop 17 are connected in series. Due to the transmitter signal S or the transmitter coil current IS that flows through the transmitter coils, a conductor strip loop current IL is induced in the conductor strip loops 17, which are inductively coupled with the transmitter coils 25. The conductor strip loop current IL flows along the conductor strip loop 17 and thus through the inductive reactance XL and an ohmic resistance RL of the conductor strip loop 17. The impedance \vec{Z} and/or the apparent resistance Z of the conductor strip loop 17 can be calculated as follows:

$$\vec{Z} == RL + jXL \qquad ( 4 )$$

$$Z = \sqrt{{RL}^{2} + {XL}^{2}} \qquad ( 5 )$$

The inductive sensor device 11 described so far is configured to determine an absolute relative position xa between sensor unit 13 and scale body 12 in measurement direction M, wherein the position variable in measurement direction M is denoted by x (FIGS. 1, 6 and 7).

Due to the transmitter coil current IS, a conductor strip loop current IL is induced in multiple conductor strip loops 17 of first scale line 18 and second scale line 19 depending on the absolute relative position xa of sensor unit 13 relative to the scale body 12. The conductor strip loop current IL flowing through the conductor strip loops 17 induces in turn a magnetic field that induces a receiver coil voltage UE as receiver coil signal E in the receiver coils 26, 27. If sensor unit 13 is moved along scale body 12 (change of the absolute relative position xa), the receiver signal in each receiver coil changes with a period corresponding to the division d1, d2 of the respective scale line 18 or 19. The exact absolute relative position xa can thus be determined within one wavelength of the position variable x corresponding to the length of the period of division d1 or d2.

By evaluating the receiver signals E of both coil groups 28 based on the different scale lines 18, 19 of different division d1, d2, a longer unambiguous range for determination of the absolute relative position xa can be achieved based on the vernier principle (nonius).

However, in practice also this measurement range is insufficiently long and additional measures are required in order to unambiguously determine the absolute relative position xa over a sufficiently long measurement path.

For this purpose, according to the invention it is provided that at least one of the scale lines—and according to the example first scale line 18 as well as second scale line 19—respectively comprises one or multiple modulating sections xm within which the apparent resistances Z or impedances of the conductor strip loops 17 change. For example, the apparent resistance Z and/or the impedance thereby increases or decreases from one end of the modulating section xm to the other end of the modulating section xm in measurement direction M. Within one modulating section xm the apparent resistance Z and/or the impedance of all conductor strip loops 17 can have different magnitudes, so that the apparent resistance Z increases or decreases from one conductor strip loop 17 to the adjacent conductor strip loop 17 from one end of the modulating section xm to the opposite end of the modulating section xm.

The change of the impedance \vec{Z} or the apparent resistance Z in one, multiple or all present modulating sections xm is thereby preferably non-linear. In other words, the impedances \vec{Z} or apparent resistances Z within a common modulating section xm do not form points on a straight line. Rather they can be points on a non-linear curve Z(x). The impedance \vec{Z} or the apparent resistance Z increases or decreases between directly adjacent conductor strip loop 17 therefore not along the entire modulating section xm by equal difference magnitudes. Particularly the ohmic resistance varies relative to reactance. This increases the determination of the absolute relative position xa and can especially contribute to increase the insensitivity with regard to temperature deviations.

The impedance \vec{Z} and according to the example, also the apparent resistance Z of each conductor strip loop is influenced by the ohmic resistance RL, wherein in the embodiment substantially exclusively the ohmic resistance RL of the conductor strip loop 17 is varied within the modulating section xm, whereas the inductive reactance XL remains substantially constant. The ratio of the inductive reactance XL relative to the ohmic resistance RL defines a phase offset that a conductor strip loop current IL of the respective conductor strip loop 17 comprises relative to the transmitter coil current IS. Therefore, the phase offset between the transmitter coil current IS and the conductor strip loop current IL induced in the conductor strip loop 17 changes within the modulating section xm dependent on the relative position between sensor unit 13 and scale body 12 in measurement direction M.

The phase offset between the transmitter coil current IS and the conductor strip loop current IL defines the phase position of the receiver signals E in the receiver coils 26, 27 relative to the transmitter coil current IS and according to the example, the phase position of the receiver coil voltages UE (here: UE1, UE2, UE3, UE4) relative to the transmitter coil current IS. Because the phase of the transmitter coil current IS is known in the evaluation unit 42 (based on the measurement signal of the measurement coil 41), the phase position of one or more receiver coil voltages UE relative to the transmitter coil current IS can be determined. Based on the known correlation between the phase position and the relative position between sensor unit 13 and scale body 12 in measurement direction M, a coarse position detection of the relative position between sensor unit 13 and scale body 12 in measurement direction M (or along the axes of the position variable x) can be carried out. If the coarse position is known, the more precise relative position within the vernier or nonius length and further within the first division d1 or the second division d2 can be determined. Accordingly, a phase modulation of the receiver signals E is carried out in order to extend the measurement range beyond multiple vernier or nonius lengths within which measurement range an unambiguous determination of the absolute relative position xa is possible.

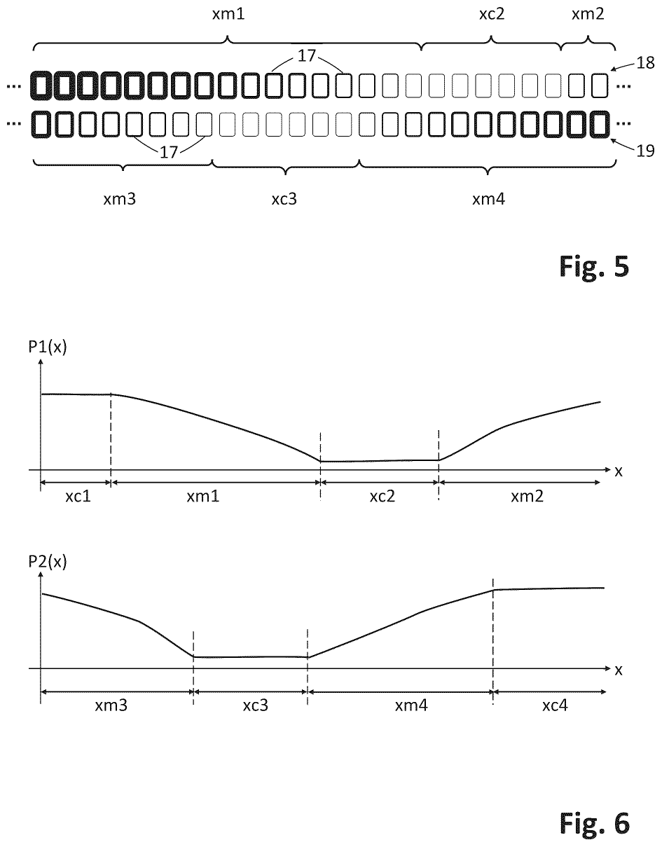

FIG. 5 schematically shows by way of example a section of scale lines 18, 19. In the embodiment each scale line 18, 19 has at least one modulating section xmi (i=natural number) and optionally at least one non-modulating section xci (i=natural number). In each non-modulating section xci the impedance or apparent resistance Z of the conductor strip loops 17 does not change. In these non-modulating sections xci, therefore, no phase modulation of the receiver signals E (according to the example receiver coil voltages UE1 to UE4) is carried out.

In FIG. 6 a first phase signal P1 based on the modulation of the first scale line 18 and a second phase signal P2 based on the modulation of the second scale line 19 are schematically illustrated by way of example respectively. In this embodiment each scale line 18, 19 comprises multiple modulating sections xmi and according to the example, two modulating sections respectively: The first scale line 18 has a first modulating section xm1 and a second modulating section xm2 and the second scale line 19 has a third modulating section xm3 and a fourth modulating section xm4.

The modulating sections xm1, xm2 or xm3, xm4 of one single scale line 18 or 19 do not adjoin one another directly, but are respectively separated from each other by one non-modulating section xci. According to the example, the first scale line 18 as a first non-modulating section xc1 as well as a second non-modulating section xc2. Between the two non-modulating section xc1, xc2 first modulating section xm1 is arranged. The second modulating section xm2 adjoins the second non-modulating section xc2. The second scale line 19 has, for example, a third non-modulating section xc3 as well as a fourth non-modulating section xc4. The third non-modulating section xc3 is arranged between the third modulating section xm3 and the fourth modulating section xm4 and the fourth non-modulating section xc4 adjoins the fourth modulating section xm4.

In doing so, a first phase signal P1 results for the first scale line 18 depending on the position variable x in measurement direction M and a second phase signal P2 for the second scale line 19 accordingly. The phase signals P1, P2 as well as the modulating sections xm1 to xm4 and the non-modulating sections xc1 to xc4 are also schematically indicated in FIG. 6.

In FIG. 6 it is in addition apparent that non-modulating sections xc1, xc2 of first scale line 18 do not overlap with non-modulating sections xc3, xc4 of second scale line 19 in measurement direction M. In doing so, it is guaranteed that in each area of scale lines 18, 19 in measurement direction M (i.e. in direction of the position variable x) a phase modulation is carried out at least in one scale line 18 or 19.

In the example shown in FIG. 6 the locus of the phase signals P1, P2 is a square. Alternatively P1, P2 can be defined to provide other locus shapes, such as a circle or a diamond shape.

The magnitude of the phase signals P1, P2 depends from the ratio of the magnitudes of the inductive reactance XL to the ohmic resistance RL respectively. If the magnitude of the ohmic resistance RL increases relative to the magnitude of the inductive reactance XL, the magnitude of the phase offset and thus the magnitude of the respective phase signal P1, P2 decreases. Thus, by means of changing this ratio, the phase signal P1, P2 can be modified and can be modulated so-to-speak. In the embodiment for this purpose the ohmic resistances RL of the conductor strip loops 17 are different from one another in the respective modulating sections xm.

The change of the ohmic resistance RL of the conductor strip loops 17 is achieved in the embodiment in that the conductor strip cross-section is changed. Thereby particularly a conductor strip thickness orthogonal to the extension plane of the conductor strip loop 17 is kept constant and rather the respective conductor strip width b of a conductor strip loop 17 compared to the adjacent conductor strip loop 17 is increased or decreased. The change of the conductor strip width b is schematically illustrated in FIG. 8.

By way of example, FIG. 8 shows 3 conductor strip loops 17 within a modulating section xm. The conductor strip width b is respectively determined orthogonal to the extension direction of a conductor strip and particularly orthogonal to the inner edge and/or outer edge of the conductor strip. The conductor strip width b of each conductor strip loop 17 is constant. This means that in the embodiment the transverse legs 20 and the longitudinal legs 21 being part of the same conductor strip loop 17 comprise equal conductor strip widths b. According to the example, the conductor strip width b of transverse leg 20 is measured in measurement direction M and the conductor strip width b of longitudinal leg 21 is measured in transverse direction Q.

Only by way of example and schematically it is illustrated in FIG. 8 that the conductor strip width b increases in the illustration from left to right from conductor strip loop 17 to conductor strip loop 17. In the illustration the left conductor strip loop 17 has a first conductor strip width b1, the center conductor strip loop 17 has a second conductor strip width b2 and the right conductor strip loop 17 has a third conductor strip width b3. Thereby the second conductor strip width b2 is larger than the first conductor strip width b1 and the third conductor strip width b3 is larger than the second conductor strip width b2. It is apparent that the number of conductor strip loops 17 within a modulating section xm can be remarkably higher than 3 and that the illustration in FIG. 8 is only to be considered as schematic basic illustration.

Preferably a minimum conductor strip width b is 100 μm. The minimum distance between directly adjacent conductor strip loops 17 is preferably minimum 100 μm. The minimum distance between two transverse legs 20 and between two longitudinal legs 21 of a common conductor strip loop 17 is preferably minimum 100 μm.

In the embodiment the conductor strip width b between the conductor strip loops 17 within a common modulating section xm is modified in a manner so that the conductor strip width b is increased or decreased starting from the center line C inward and outward relative to the adjacent conductor strip loop 17. Therefore, for all conductor strip loops 17 within a common modulating section xm center line C has the same dimension and shape in measurement direction M as well as in transverse direction Q. It results therefrom in turn that within the modulating section also a loop height H of the conductor strip loop 17 and a loop width W of the conductor strip loop 17 increases with increasing conductor strip width b. In the example of FIG. 8 this means that the conductor strip loop 17 having the first conductor strip width b1 has a first loop height H1 and a first loop width W1. Analog to this the conductor strip loop 17 having the second conductor strip width b2 has a second loop height H2 and a second loop width W2 and the conductor strip loop 17 having the third conductor strip width b3 has a third loop height H3 and a third loop width W3.

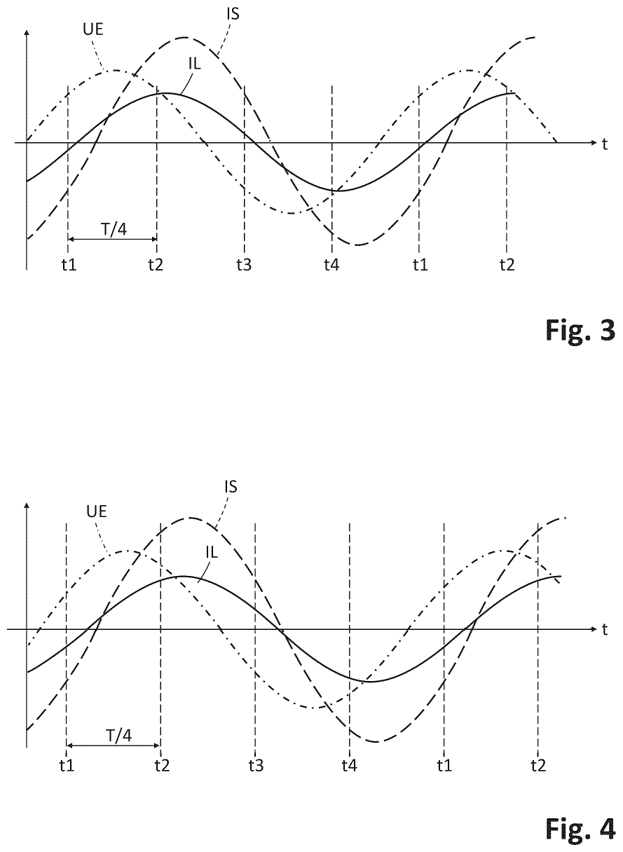

By way of example, temporal progresses of a transmitter coil current IS, a conductor strip loop current IL as well as a receiver coil voltage UE are illustrated in FIGS. 3 and 4 respectively. Therefrom a phase offset between transmitter coil current IS and conductor strip loop current IL results depending on the impedance, particularly depending on the apparent resistance Z, of the respective conductor strip loop 17. In the preferred embodiment the phase offset between the receiver coil voltage UE and the conductor strip loop current IL is substantially independent from the electrical characteristics of the receiver coils 26, 27, because the receiver coils 26, 27 are connected to a relatively high impedance in the evaluation unit 42. The phase position of the receiver coil voltages UE relative to the transmitter coil current IS is therefore characterizing for the phase position of the conductor strip loop current IL relative to the transmitter coil current IS and can therefore be used for determination of the phase signal P1, P2.

In the embodiment described here at least one of the receiver coil voltages UE of each coil group 28 is sampled for producing the respective phase signal P1, P2. For example, the first receiver coil voltage UE1 can be used for determination of the first phase signal P1 and the third receiver coil voltage UE3 can be used for determination of the second phase signal P2.

In the embodiment a sampling of the continuous receiver coil voltage UE (which can also be denoted as A/D conversion) is carried out by means of the evaluation unit 42. Preferably the receiver coil voltage UE is detected or sampled during each complete period multiple times, in the embodiment four times in each period, i.e. in a first point in time of detection t1, a second point in time of detection t2, a third point in time of detection t3 as well as a fourth point in time of detection t4 within each period, as schematically illustrated in FIGS. 3 and 4. The detection is carried out in uniform time intervals, wherein the time interval between two directly subsequent points in time of detection corresponds to a phase angle of 90° or one fourth of the period T. From the detected receiver coil voltages the following voltage differences can be calculated by means of subtraction:

$${UE}_{13} = UE ( t 1 ) - UE ( t 3 ) \qquad ( 6 )$$

$${UE}_{24} = UE ( t 2 ) - UE ( t 4 ) \qquad ( 7 )$$

From these differences in turn a phase value p can be calculated:

$$φ = arc tan 2 ( {UE}_{13} , {UE}_{24} ) \qquad ( 8 )$$

This phase value y thus depends on the impedance or the apparent resistance Z, which varies spatially in measurement direction M within the at least one modulating section xm (according to the example four modulating sections). Therefrom first phase signal P1 for the first scale line 18 and second phase signal P2 for second scale line 19 result. This in turn allows a coarse evaluation of the absolute relative position xa between sensor unit 13 and thus a relatively long measurement range.

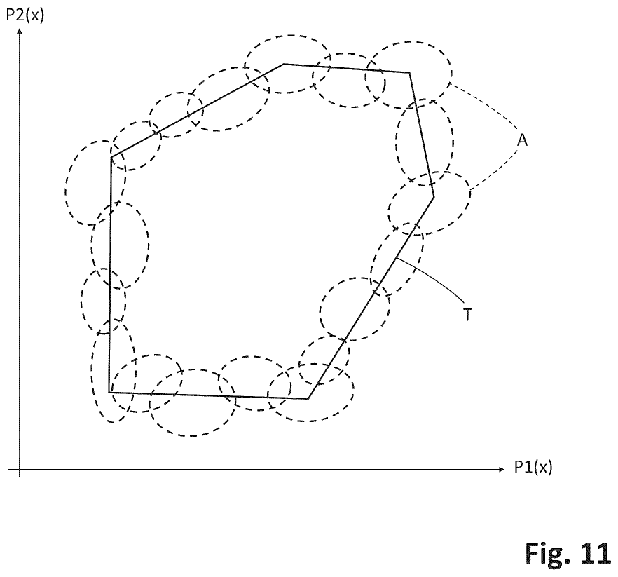

For example, based on the first phase signal P1 and the second phase signal P2, a (coarse) value of the absolute relative position xa can be assigned to the phase signals P1, P2 in a table or another assignment stored in the evaluation unit 42. The determined first and second phase signals P1, P2 may vary due to external influences, e.g. due to variations of the ohmic resistance of scale loops 17 due to temperature changes. A phase trajectory PT (FIG. 11) characterizing the correlation between first and second phase signals P1, P2 (locus) can have different shapes, as already explained above. However, the points defining this phase trajectory cannot be exactly defined, but vary depending on external influences, e.g. due to temperature changes. However, average values for the first and second phase signal P1, P2 can be determined and/or ranges A of expected values on the phase trajectory PT can be determined. The progress of the phase trajectory PT can have a closed shape (e.g. circle, square, diamond, etc.). One single and complete turn around the phase trajectory PT corresponds to the measurement range with unambiguous (coarse) position determination.

However, it would also be possible to limit the measurement range corresponding to a continuous section of the phase trajectory PT.

A table can be defined characterizing the correlation of the first and second phase signals P1, P2. This table particularly contains only phase values that allow unambiguously position determination. This means that coarse Vernier ranges can be distinguished from one another. With reference to FIG. 11, ranges A of expected values have to be selected and used for the table that do not overlap with one another. In doing so, ambiguity is eliminated.

Preferably environmental influence (particularly temperature) that could result in a variation of the first and/or second phase signal P1, P2 can be determined and can be used as additional parameter in the table containing the values for the first and second phase signal P1, P2 (reflecting the dependency shown in FIG. 11). In doing so, the sizes of the ranges A can be reduced and thus a more reliable coarse position determination is made possible.

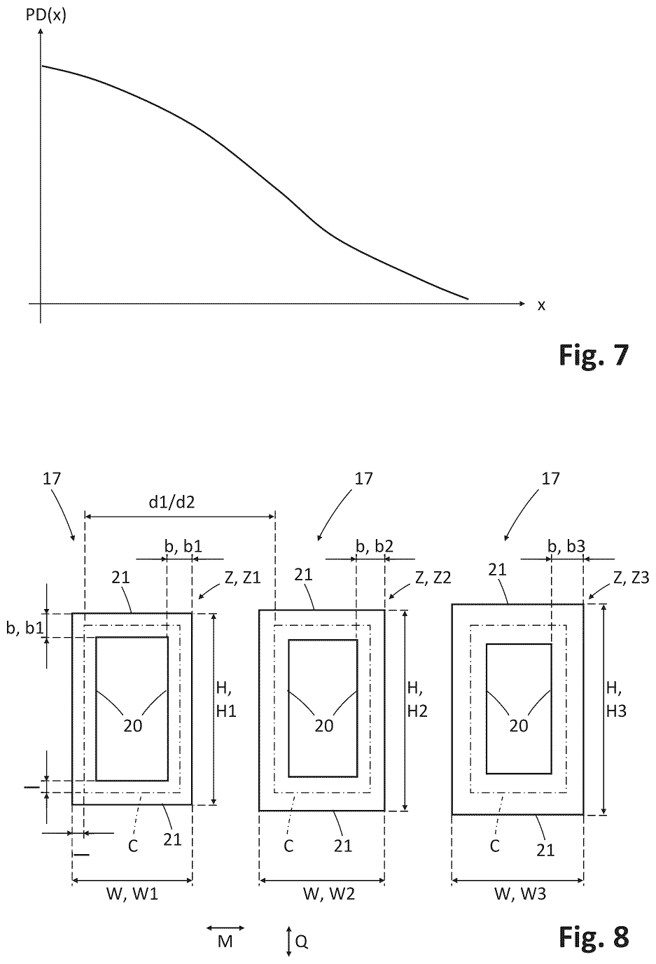

A modified embodiment of the present invention for determination of the rough position of sensor unit 13 relative to scale body 12 can be explained based on FIG. 7. FIG. 7 shows a phase difference signal PD depending on the position variable x. The phase difference signal PD is formed by calculating the difference between first phase signal P1 determined based on first scale line 18 and second phase signal P2 determined based on second scale line 19. The two phase signals P1, P2 can thereby have a different qualitative progress than illustrated in FIG. 6. Preferably first phase signal P1 continuously decreases, whereas second phase signal P2 continuously increases or vice versa (e.g. with increasing position variable x) for determination of phase difference signal PD. This can be achieved, for example, in that the ohmic resistance RL of conductor strip loops 17 of first scale line 18 increases continuously, whereas the ohmic resistance RL of the conductor strip loops 17 of second scale line 19 decreases continuously or vice versa (e.g. with increasing position variable x).

In a preferred embodiment segments xc1 and xm1 are used for the first phase signal P1 and xm4 and xc4 for the second phase signal P2. The phase trajectory PT (locus) resulting therefrom has two phase trajectory segments extending orthogonally to one another (‘L’ rotated by 180 degrees). On each of the two phase trajectory segments, one of the phase signals P1, P2 is constant and the receiver signal is large, which provides good signal quality.

The invention refers to an inductive sensor device 11, particularly for a measurement device or a measurement instrument 10, preferably a mobile measurement instrument 10 that is operated by means of a battery. The inductive sensor device 11 has a scale body 12 having a multiplicity of electrically conductive conductor strip loops 17. The conductor strip loops 17 are arranged in a measurement direction M in at least one scale line and preferably in a scale line 18 having a first division d1 and in a second scale line 19 having a second division d2. A sensor unit 13 is movably arranged on scale body 12 in measurement direction M. The sensor unit 13 has one coil group 28 respectively for each present scale line 18, 19, e.g. comprising a transmitter coil 25 for producing a transmitter signal S and at least one receiver coil 26, 27. Each coil group 28 provides at least one receiver signal E for an evaluation unit 42 for determination of an absolute relative position xa of sensor unit 13 relative to scale body 12 in measurement direction M. At least one of the present scale lines 18, 19 has at least one modulating section xm, within which the impedances, particularly the apparent resistances Z, of conductor strip loops 17 change from one end of the modulating section xm to the other end of the modulating section xm in measurement direction M, wherein particularly the apparent resistances Z increase or decrease, whereby the at least one receiver signal E is modulated with regard to its phase position relative to the transmitter signal S. The modulation is considered when determining the absolute relative position xa in the evaluation unit 42. For example, in doing so the measurement range can be enlarged within which the absolute relative position xa can be determined unambiguously. This position determination is in addition robust against assembly tolerances.

### LIST OF REFERENCE SIGNS

10 measurement instrument
11 sensor device
12 scale body
13 sensor unit
17 conductor strip loop
18 first scale line
19 second scale line
20 transverse leg
21 longitudinal leg
25 transmitter coil
26 first receiver coil
27 second receiver coil
28 coil group
29 circuit branch
30 first node
31 second node
32 transmitter circuit
33 parallel oscillating circuit
34 oscillating circuit capacitance
35 oscillating circuit inductance
36 series resistance
37 controlled switch
38 control input
39 transmitter control unit
40 control device
41 measurement coil
42 evaluation unit
43 circuit board
44 top side of circuit board
45 measurement loop
46 first end point of measurement loop
47 second end point of measurement loop
48 central loop
49 shielding
A range of expected values
b conductor strip width
b1 first conductor strip width
b2 second conductor strip width
b3 third conductor strip width
C central line
d1 first division
d2 second division
E receiver signal
GND ground potential
H loop height
H1 first loop height
H2 second loop height
H3 third loop height
IS transmitter coil current
IL conductor strip loop current
UE receiver coil voltage
UE1 first receiver coil voltage
UE2 second receiver coil voltage
UE3 third receiver coil voltage
UE4 fourth receiver coil voltage
M measurement direction
P1 first phase signal
P2 second phase signal
PD phase difference signal
PT phase trajectory
Q transverse direction
RL ohmic resistance of conductor strip loop
S transmitter signal
SW switch signal
T period of receiver coil voltage
t time
t1 first point in time of detection
t2 second point in time of detection
t3 third point in time of detection
t4 fourth point in time of detection
UDC supply direct voltage
W loop width
W1 first loop width
W2 second loop width
W3 third loop width
x position variable in measurement direction
xc non-modulating section
xc1 first non-modulating section
xc2 second non-modulating section
xc3 third non-modulating section
xc4 fourth non-modulating section
xa absolute relative position
XL inductive reactance of conductor strip loop
xm modulating section
xm1 first modulating section
xm2 second modulating section
xm3 third modulating section
xm4 fourth modulating section
Z apparent resistance of conductor strip loop

1. An inductive sensor device (11) comprising:
a scale body (12) having multiple electrically conductive conductor strip loops (17) that are arranged in at least one scale line (18) having a respectively defined division (d1, d2), wherein the at least one scale line (18, 19) extends parallel to a measurement direction (M);
a sensor unit (13), which is movably arranged in the measurement direction (M) on the scale body (12) and which comprises for each scale line (18, 19) at least one transmitter coil (25) for application of at least one transmitter signal (S) and at least one receiver coil (26, 27) for providing a receiver signal (E); and
an evaluation unit (42), which is configured to evaluate the receiver signal or signals (E) and to determine therefrom an absolute relative position (xa) between the sensor unit (13) and the scale body (12);
wherein the at least one scale line (18, 19) comprises a modulating section (xm) extending in the measurement direction (M), wherein within the modulating section individual ones of the conductor strip loops (17) have impedances and/or apparent resistances (Z) which are different from one another, and wherein the evaluation unit (42) is configured to evaluate a modulation of the receiver signal or signals (E) resulting from the impedances and/or apparent resistances (Z) that change within the modulating section (xm).

2. The inductive sensor device according to claim 1, wherein the conductor strip loops (17) are arranged with a first division (d1) in a first scale line (18) and with a second division (d2) in a second scale line (19) and wherein the first and second scale lines (18, 19) are arranged adjacent to one another in a transverse direction (Q).

3. The inductive sensor device according to claim 1, wherein two receiver coils (26, 27) of the at least one receiver coil are assigned to each scale line (18, 19).

4. The inductive sensor device according to claim 1, wherein each of the conductor strip loops (17) within the at least one modulating section (xm) have impedances and/or apparent resistances (Z) that are different from one another.

5. The inductive sensor device according to claim 1, wherein the impedances and/or apparent resistances (Z) of the individual ones of the conductor strip loops (17) in the modulating section (xm) are different to each other in that the individual ones of the conductor strip loops (17) have different ratios of a reactance (XL) relative to an ohmic resistance (RL).

6. The inductive sensor device according to claim 1, wherein a change of the impedance and/or apparent resistance (Z) between the individual ones of the conductor strip loops (17) which are adjacent in the measurement direction (M) within the at least one modulating section (xm) is non-linear.

7. The inductive sensor device according to claim 1, wherein a change of the impedance and/or apparent resistance (Z) between the individual ones of the conductor strip loops (17) which are adjacent in the measurement direction (M) within the at least one modulating section (xm) is exclusively or at least primarily based on a change of an ohmic portion of the apparent resistance (Z).

8. The inductive sensor device according to claim 1, wherein multiple conductor strip loops (17) within the at least one modulating section (xm) have conductor strip widths (b) that are different from one another.

9. The inductive sensor device according to claim 8, wherein each conductor strip loop comprises a loop height (H) in a transverse direction (Q) and a loop width (W) in the measurement direction (M) and wherein two conductor strip loops (17) having different conductor strip widths (b1, b2, b3) comprise loop heights (H1, H2, H3) of different magnitude and loop widths (W1, W2, W3) of different magnitude.

10. The inductive sensor device according to claim 1, wherein each conductor strip loop (17) of the multiple conductor strip loops comprises two transverse legs (20) each extending in a straight line in a transverse direction (Q).

11. The inductive sensor device according to claim 1, wherein each conductor strip loop (17) of the multiple conductor strip loops comprises two longitudinal legs (21) each extending in a straight line in the measurement direction (M).

12. The inductive sensor device according to claim 1, wherein each individual conductor strip loop (17) of the multiple conductor strip loops comprises a constant conductor strip width (b).

13. The inductive sensor device according to claim 1, wherein the at least one scale line (18, 19) comprises a non-modulation section (xc) extending in the measurement direction (M) in which each of the conductor strip loops (17) have equal impedances and/or equal apparent resistances (Z).

14. The inductive sensor device according to claim 13, wherein each of the conductor strip loops (17) within the non-modulating section (xc) have equal conductor strip cross-sections and equal conductor strip widths (b).

15. The inductive sensor device according to claim 2, wherein the at least one scale line (18, 19) comprises a first scale line (18) and a second scale line (19) that each comprise at least one non-modulating section (xc) respectively, wherein the at least one non-modulating section of each scale line are arranged in a non-overlapping manner in the measurement direction (M).

16. The inductive sensor device according to claim 1, wherein the evaluation unit (42) is configured to determine a phase signal (P1, P2) from the receiver signal or signals (E), wherein the phase signal (P1, P2) describes a phase offset between the at least one transmitter signal (S) and a conductor strip loop current (IL), which is induced in at least one of the conductor strip loops (17) due to the at least one transmitter signal (S).

17. The inductive sensor device according to claim 16, wherein the evaluation unit (42) is configured to sample the receiver signal or signals (E) multiple times and to determine one sample value respectively.

18. The inductive sensor device according to claim 17, wherein the evaluation unit (42) is configured to determine a phase value (φ) for the phase signal (P1, P2) from the sample values of the receiver signal (E).
